(19) United States
(12) Patent Application Publication
(10) Pub. No.: US 2008/0098689 A1
(43) Pub. Date: May 1, 2008

(54) METHOD FOR SHAPING CONCRETE BLOCKS AND/OR CONCRETE SLABS

(76) Inventor: Hans-Josef Metten, Bergisch Gladbach (DE)

Correspondence Address: NEXSEN PRUET, LLC, P.O. BOX 10648, GREENVILLE, SC, 29603, US

(21) Appl. No.: 11/924,822

(22) Filed: Oct. 26, 2007

(30) Foreign Application Priority Data
Oct. 27, 2006 (DE) 10 2006 050754.1

(51) Int. Cl. B28B 7/22; B28B 7/20

(52) U.S. Cl. 52/742.14; 52/745.19

(57) ABSTRACT

A method for shaping concrete blocks and/or concrete slabs of various formats and sizes. The shaping taking place in concrete-filled molds with or without additional facing concrete. Dies or matrices corresponding to the block surface or slab surface have recesses or projections for impressing the surfaces. The concrete blocks or concrete slabs are then removed from the molds before setting and are cured externally and the surfaces are further worked in a subsequent operation. The recesses formed are grooves having parallel, oblique, planar or curved walls and/or roots and the projections being tooth strips having parallel, oblique, planar or curved walls and/or tips. The grooves and/or tooth strips extend over the entire surface of the dies and consequently over the entire surface of the concrete blocks or concrete slabs. In a subsequent operation the surfaces are blasted with liquids or solids. A final step may include application of a coating containing acrylate resin.

### BACKGROUND OF THE INVENTION

The invention relates to a method for shaping concrete blocks and/or concrete slabs of various formats and sizes. A method for fabricating and/or working concrete blocks is known from European Patent 0 319 972 B1, which discloses dies having recesses or projections that are randomly distributed over the die area and form a reciprocal surface on the concrete blocks. In a subsequent operation the surfaces and, as appropriate, also the edges of the concrete blocks are cleaned of loose parts and additionally roughened or damaged. Concrete blocks or concrete slabs having a rough surface with small departures from planarity but no ribbed or broached texture are obtained by the known method. Further, a method and an apparatus for artificially aging concrete blocks are known from German Patent DE 36 21 276 A1, where cured concrete blocks or concrete slabs are worked with a chisel-like striking tool so that an irregularly worked surface is produced.

### BRIEF DESCRIPTION OF THE INVENTION

The herein disclosed method for shaping concrete blocks and slabs provides a ribbing on the surfaces of the concrete blocks or concrete slabs. The surface formed by the method renders the block or slab safe for walking and slip-resistant. By virtue of the grooves or tooth strips applied to the dies or matrices, substantially reciprocal grooves and tooth strips are applied to or impressed into the surfaces of the concrete blocks or concrete slabs. Because the walls and/or roots and/or tips of the grooves or tooth strips are fashioned as parallel to one another, oblique to one another, planar or also curved, grooves or tooth strips having various flank, root or tip shapes are produced on the concrete blocks or concrete slabs. The grooves or tooth strips extend over the entire surface of the concrete blocks or concrete slabs, preferably in a regular texture, so that broaching or ribbing, that is, a special texture, is imparted to the surface. The surfaces are blasted with liquids or solids in a subsequent step. Finish working with liquid containing predominantly water is preferably carried out before the surfaces of the concrete blocks or concrete slabs have cured. Finish working with solids takes place after curing because the loading of the surface is much more intensive, so that working before curing might cause too-severe damage to the surface. The solids are preferably steel shot, because these exhibit a smooth surface and work the concrete blocks and concrete slabs intensively but not roughly. Finish working with liquids and solids is effected with jets generated for example by nozzles. There can be a plurality of jets disposed at an angle to one another. They can be moved in nonuniform fashion relative to the concrete block surface or relative to one another. The liquids or solids can also be supplied in nonuniform fashion. Finally, the concrete blocks or concrete slabs can also be moved in irregular/nonuniform fashion during finish working. Finish working with liquids and/or solids also results in the surfaces becoming safer for walking and more slip-resistant.

According to a modified proposal of the invention, instead of working with liquids or solids, it is proposed to grind flat the surfaces of the concrete blocks or concrete slabs and thus the terminal tips of the tooth strips or highs, and indeed to such a degree that the terminal tips or highs exhibit small planar surfaces. Aside from the modified visual impression, a walking surface having an increased number of edges and drainage grooves is generated in this way. The tooth strips and grooves are an effective measure for enhancing the safety of walking, in particular in the case of a ground surface combined with a dirt-inhibiting coating. According to another proposal of the invention, instead of the grooves being impressed, they are milled into the surfaces after the pressing of the concrete blocks or concrete slabs. The surfaces are preferably ground afterward, as described above. The surfaces can also be blasted. The safety of walking and/or the slip resistance is increased in this way, in particular in combination with the application of a coating described.

In preferred embodiment of the invention the grooves or tooth strips are aligned parallel to one another. They preferably run in linear fashion and parallel to one edge of the concrete blocks or concrete slabs, both the longitudinal edge and the transverse edge being usable as starting line. The grooves or tooth strips can also run obliquely to one of the edges and rib or broach the surfaces of the concrete blocks or concrete slabs diagonally. Because the grooves or tooth strips can be applied to the dies in arbitrary fashion, arbitrary shapes or textures can also be generated on the surfaces of the concrete blocks or concrete slabs, a fish-scale pattern also being possible. The cross section of the grooves or tooth strips can exhibit arbitrary shapes as viewed in cross section. Cross sections in circular arc shape also being possible, as well as rectangular and triangular cross sections having straight or curved walls.

### BRIEF DESCRIPTION OF THE DRAWINGS

Exemplary embodiments of the invention are illustrated in the accompanying drawings, in which:

FIG. 1 is a perspective view of a concrete slab having a ribbed surface;

FIG. 2 is an end view of the slab shown in to FIG. 1;

FIG. 3 is a perspective view of a concrete slab according to FIG. 1 having ribbing running obliquely;

FIG. 4 is a perspective view of a concrete slab having ribbed/broached surface, the terminal tips having been ground flat; and

FIG. 5 is a lateral view of the slab according to FIG. 4.

### DETAILED DESCRIPTION OF THE INVENTION

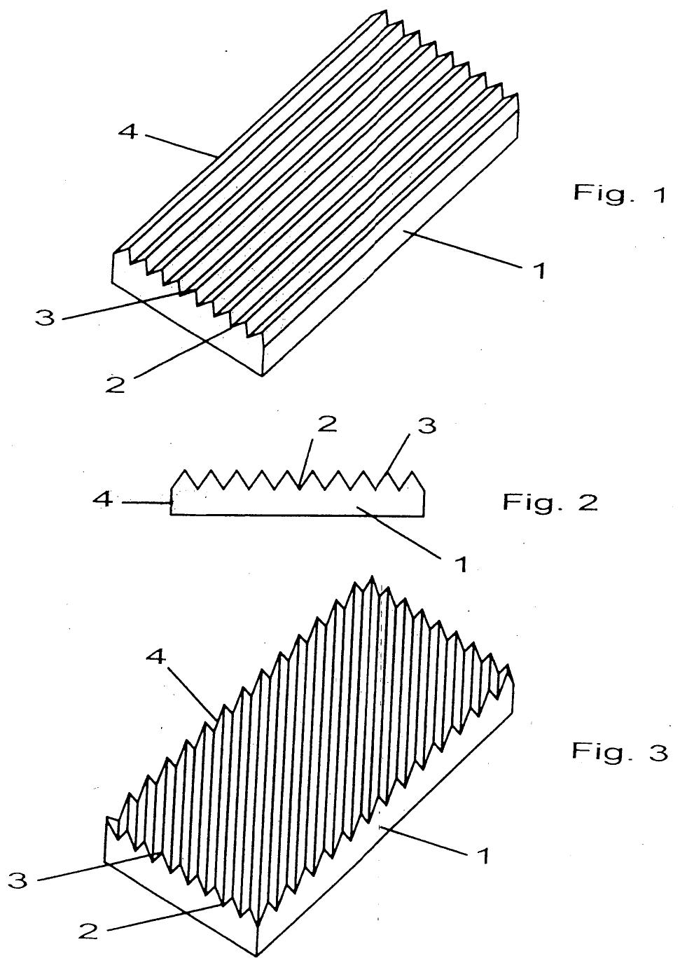

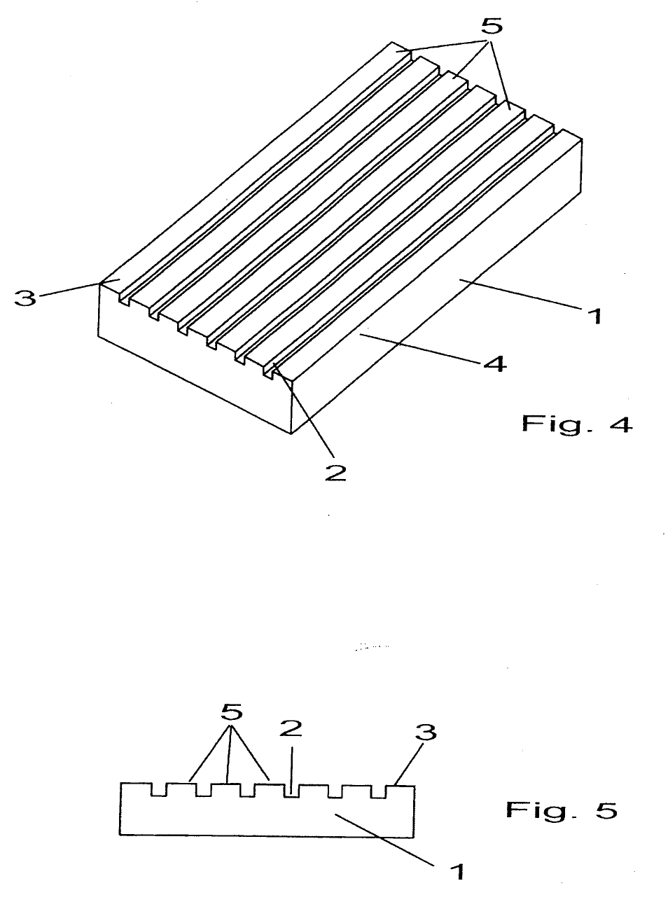

In FIGS. 1 to 5, insofar as individually illustrated, reference character 1 identifies a concrete slab that exhibits a longitudinal and a transverse extension and is fashioned as a rectangle. The concrete slab was fabricated by one of the shaping methods described herein, wherein the die associated with the concrete slab or the matrix in the corresponding working system has grooves and tooth strips that form corresponding grooves 2 and tooth strips 3 on the surface of concrete slab 1. Slabs 1 can, however, also be fabricated with planar-surfaced dies, grooves 2 being fabricated by a milling operation. In correspondence with the disposition of grooves and tooth strips on the dies, the grooves 2 and the tooth strips 3 on concrete slab 1 have exhibit arbitrary shapes and designs. Grooves 2 and tooth strips 3 of the concrete slab according to FIGS. 1 and 2 are aligned parallel to one longitudinal edge 4 of concrete slab 1, while grooves 2 and tooth strips 3 on the surface of concrete slab 1 according to FIG. 3 are fashioned obliquely.

As illustrated in FIGS. 4 and 5, the terminal tips 5 of tooth strips 3, identified by the reference character 5, can be ground flat. The terminal tips 5 can, however, also be fabricated by corresponding planar rows and tooth strips on the die or by a planar surface of the die and milling of grooves 2 with no flat grinding operation.

The surfaces of the concrete blocks or concrete slabs can additionally be treated in the fresh or the cured condition with a finish containing, for example, acrylate, paint or the like, so that a surface is obtained that exhibits a reduction or obstruction of dirt absorption and yields more-intense color and improved color fastness as well as ease of cleaning.

What is claimed is:

1. A method for shaping concrete slabs, comprising the steps of:
providing concrete molds,
filling said molds with uncured concrete,
impressing the surface of said uncured concrete slab with a die corresponding to size to said surface, said die having parallel tooth strips and recesses extending over the entire surface of said die,
removing said slabs from said molds,
curing said slabs,
finish working said surface of said slabs by impacting with a flowable substance.

2. The method of claim 1, wherein said finish working is carried out by impacting said surface with liquid before the curing of said concrete slabs.

3. The shaping method of claim 2 wherein said liquid contains predominantly water.

4. The shaping method of claim 1, wherein said finish working is carried out with solids after the curing of said concrete slabs.

5. The shaping method of one of claim 4, wherein said solids are steel shot.

6. The shaping method of claim 1 wherein finish working is carried out with jets at an angle to one another.

7. The shaping method of claim 6 wherein the jets are moved in nonuniform fashion relative to one another.

8. The shaping method of claim 6 wherein said jets apply material in a nonuniform fashion.

9. The shaping method of claim 1, wherein the concrete slabs are moved in an irregular manner during finish working.

10. A method for shaping a concrete slab having a top surface, comprising
providing concrete molds for forming said slab,
providing a die with an impression face conforming to said top surface and having recesses in its entire impression face,
impressing said top surface of said slab with said die prior to curing of said concrete to form ridges in said top surface with terminal tips,
removing said slab from said mold,
curing said slab,
flat grinding said top surface to provide ridges with uniform elevation and flattened tips.

11. A method of shaping a concrete slab,
providing a mold for said slab,
filling said mold with concrete,
removing said slab from said mold before setting of said concrete,
curing said slab,
milling a surface of said slab forming grooves and tooth strips, and
flat grinding said tooth strips to form flattened tips thereon.

12. A method of shaping concrete slabs, comprising the step of:
providing molds for said slabs,
filling said molds with concrete, to form slabs with a horizontally disposed top surface,
removing said slabs from said molds before said concrete cures,
milling the entire top surface to form tooth strips, and
blasting said top surface by discharging a substance from a plurality of jets.

13. The shaping method of claim 12 wherein said tooth strips are parallel to one another.

14. The shaping method of claim 12 wherein said tooth strips run obliquely to one edge of the associated slab.

15. The shaping method of claim 12 wherein said tooth strips have a triangular shape when viewed in cross section.

16. The shaping method of claim 15 including the step of flattening the tops of aid tooth strips prior to the blasting step.

17. The shaping method of claim 12 wherein said tooth strips have a rectangular shape when viewed in cross section.

18. The shaping method of claim 12 including the step of
applying a finish containing acrylate resin to said top surface after the blasting step.

19. The method of claim 1 including, the step of applying a finish coating containing acrylate resin to said surface after said finish working step.
